(19) United States
(12) Patent Application Publication
(10) Pub. No.: US 2016/0165369 A1
(43) Pub. Date: Jun. 9, 2016

(54) SCHOOL INTERCOM SYSTEM

(71) Applicant: Rauland-Borg Corporation, Mount Prospect, IL (US)

(72) Inventors: Michael C. Perkins, Havana, IL (US); Reuben P. Garcia, Evanston, IL (US); Stacie V. Dinse, Des Plaines, IL (US); Alan Arsinow, Des Plaines, IL (US); Steve Goering, Evanston, IL (US); Karthik N. Srivathsa, Schaumburg, IL (US); Peter C. Holtermann, Wilmette, IL (US)

(21) Appl. No.: 14/563,404

(22) Filed: Dec. 8, 2014

(51) Int. Cl. H04R 27/00; H04L 29/08; G06F 3/0484

(52) U.S. Cl. CPC H04R 27/00; G06F 3/04847; G06F 3/04842; H04L 67/02; H04L 67/10; H04R 2227/003

(57) ABSTRACT

A system and method are provided for control and integration of a school intercom system within each of a plurality of schools within a school district. The plurality of school intercom systems are controlled, at the district level, by a district datacenter which administers a web-based user interface. An administrator can log into the web-based user interface to configure the functionality of the various school intercom systems within the various schools of the districts. The log in credentials control which schools the administrator will have access to. Over the web-based user interface, the school administrator can configure the school intercom systems such that they are configured to perform several functions such as live paging, event schedule management, emergency event management and running pre-defined sequence events.

### FIELD OF THE DISCLOSURE

This disclosure generally relates to a school intercom system, and more particularly to a school intercom system integration and operation at a school district level.

### BACKGROUND OF THE INVENTION

An intercom system is typically used in a school to maintain class schedules and make announcements to individuals within school building(s). In this manner, students and staff within the school will be able to maintain a daily schedule for the school and be able to receive specific information via the announcements.

Generally, individual schools are organized as part of a larger school district. A school district includes several schools typically related by having close geographic locations to each other. Typically, the school district is tasked with management of the individual schools covered by the district. As part of that management, the school district will have some control over an individual school's daily schedule. Moreover, the school district may also desire to make broad announcements to all schools located within the district. Typically, setting an intercom schedule at the district level is cumbersome in that it requires programming each intercom event schedule at each individual school.

Each individual school within the broader school district is situated on a school campus. The individual school is generally composed of classrooms, offices, student common areas, libraries, sports facilities and other such rooms and event spaces. Each of these rooms and spaces are generally physically separated by doors and walls. Accordingly, individual announcements may be made in each individual space via the intercom system.

A school intercom system may also provide as an emergency alert system. Historically, the school intercom system has been functional to inform individual schools of hazards and natural disasters. For instance, the intercom system may be utilized to warn personnel within the school of a fire or a tornado. Additionally, the school intercom system may be utilized to warn of other dangerous activities occurring within the school or district at large, such as an intruder suspected of causing or desiring to cause harm to individuals within the school.

In view of above, there is a need for a school intercom system that includes a centralized scheduling system that could create event schedules for individual schools at the district level and pass those schedules off to the individual schools. There is also a need for a school intercom system to be able to make broad announcements to each school within the district via a single point and then distribute that announcement to each school, as opposed to having to make an individual announcement at each school separately. Further, there is also a need for the school intercom system to function as a tool for first responders responding to an emergency situation at one or more schools within the school district.

### BRIEF SUMMARY OF THE INVENTION

One embodiment provides a distributed intercom system. The system includes a district server configured to manage at least one intercom system located within a district location managed by the district server. The system further includes a district network configured to communicatively couple the at least one intercom system and the district server. And the system further includes a web-based user interface configured to allow access to the district server to control the at least one intercom system, wherein the at least one intercom system located within the district location includes a network switch configured to integrate intercom equipment associated with the district location into the at least one intercom system. The district location further includes a plurality of zones where each zone of the plurality of zones defines a physical space within the district location or an aggregate grouping of zones and each zone comprises zone specific intercom equipment of the intercom equipment associated with the district location. And the district location further includes a controller communicatively coupled to the network switch and configured to control the intercom equipment associated with the district location.

Another embodiment includes a method of operating an intercom system within a district location during an emergency. The method includes receiving an initiation signal at a controller for an intercom system of the district location, where the initiation signal indicating that an emergency event is presently occurring within the district location. The method further includes accepting check-in messages from one or more system devices located within the intercom system of the district location, where the check-in messages indicate that the physical space in which one or more system devices is located are not in immediate danger from the emergency event. The method further includes generating a check-in exception list upon the expiration of a check-in timer, where the check-in list provides an indication that a specific system device has provided a check-in message. And the method further includes displaying the check-in exception list at a designated console.

Yet another embodiment includes a district datacenter providing control for a plurality of intercom systems located within a plurality of locations within a district administered by the district datacenter. The district datacenter includes one or more servers configured to administer the plurality of intercom systems, and a web-based user interface being hosted by the one or more servers and accessible by a computing device. Wherein the web-based user interface is configured to accept user credentials and provide access to a setup and control interface for each intercom system of the plurality of intercom systems to which the user credentials indicate a user has access.

### BRIEF DESCRIPTION OF THE SEVERAL VIEWS OF THE DRAWING(S)

The accompanying drawings incorporated in and forming a part of the specification illustrate several aspects of the present invention and, together with the description, serve to explain the principles of the invention. In the drawings:

FIG. 1 is a block diagram of a school intercom system at a school district level, according to an exemplary embodiment;

FIG. 2 is a block diagram of components of the school intercom system of FIG. 1, at the individual school level, according to an exemplary embodiment;

FIGS. 3-17 show screenshots of a user interface for controlling the school intercom system of FIG. 1, according to an exemplary embodiment;

FIG. 18 is a flow chart illustrating an operational flow for the school intercom system of FIG. 1 during an emergency situation, according to an exemplary embodiment;

FIG. 19 is a flow chart illustrating an operational flow for the school intercom system of FIG. 1 during an intercom call, according to an exemplary embodiment;

FIG. 20 is a flow chart illustrating an operational flow for the school intercom system of FIG. 1 during a file page, according to an exemplary embodiment;

FIG. 21 is a flow chart illustrating an operational flow for the school intercom system of FIG. 1 during sequence configured to play audio, according to an exemplary embodiment; and

FIG. 22 is a flow chart illustrating an operational flow for the school intercom system of FIG. 1 during a sequence for performing an action, according to an exemplary embodiment.

While the disclosure will be described in connection with certain preferred embodiments, there is no intent to limit it to those embodiments. On the contrary, the intent is to cover all alternatives, modifications and equivalents as included within the spirit and scope of the disclosure as defined by the appended claims.

### DETAILED DESCRIPTION OF THE INVENTION

Typically, individual schools are arranged into school districts based on a geographic proximity between each school. Further, each school includes intercom equipment that allows for communication of a school schedule and for communication between locations within the school and the district.

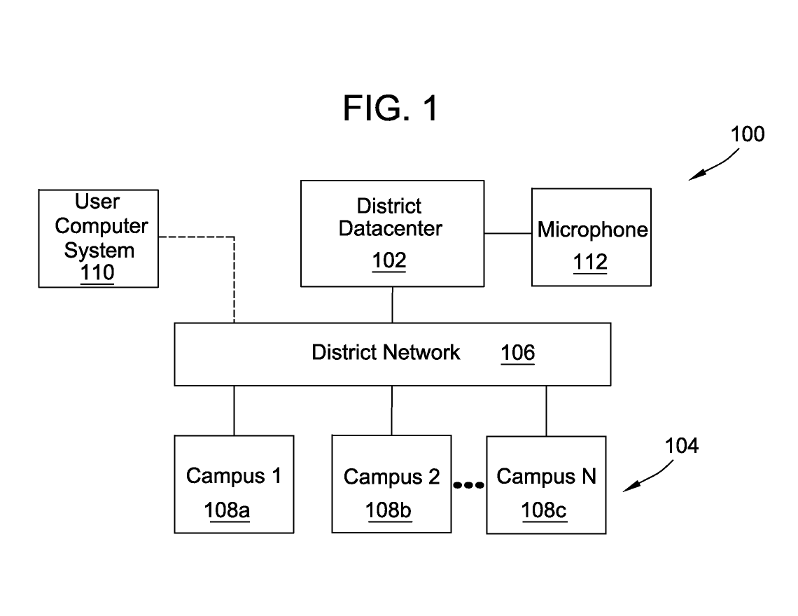

As illustrated in FIG. 1, each school intercom system is organized into a school district intercom system 100. The school district intercom system 100 includes a plurality of school campuses 104 within various district locations associated with the district. As illustrated, the plurality of school campuses 104 are interconnected through a district network 106, which in turn interfaces the plurality of school campuses 104 with a district datacenter 102. The district datacenter 102 includes a server or servers each with an associated processor or processors running a networked application controlling an intercom system within each of the plurality of school campuses 104. The networked application provides school district administrators with the ability to control all communication among the plurality of school campuses 104. This control is provided through a web-based user interface, which allows control over bell schedules, announcements and other calendar management tools along with enabling emergency notifications for lockdown, lock out and evacuation events. School administers access this web-based user interface via a user computer system 110, which is communicatively coupled to the district network 106.

The user computer system 110 can be any computer system that is capable of communicating with the district network 106 over a web-based user interface. Further, access to the web-based user interface from the user computer system 110 is granted based on an administrator's or user's login credentials. Any time a user accesses the web-based user interface, login credentials will be required before any functionality is provided. The login credentials not only provide access to the web-based user interface, but they also provide a level of access to the intercom systems at the plurality of school campuses 104. For instance, in certain embodiments, the plurality of school campuses 104 may include individual school campuses 1-N, 108a, 108b and 108c, and the individual user may only be authorized to control the intercom system at a single campus such as school campus 1 108a. Therefore, upon entering the user login credentials, the district datacenter 102 administrating the web-based user interface will look up the user's level of access and provide control only according to that access via the web-based user interface.

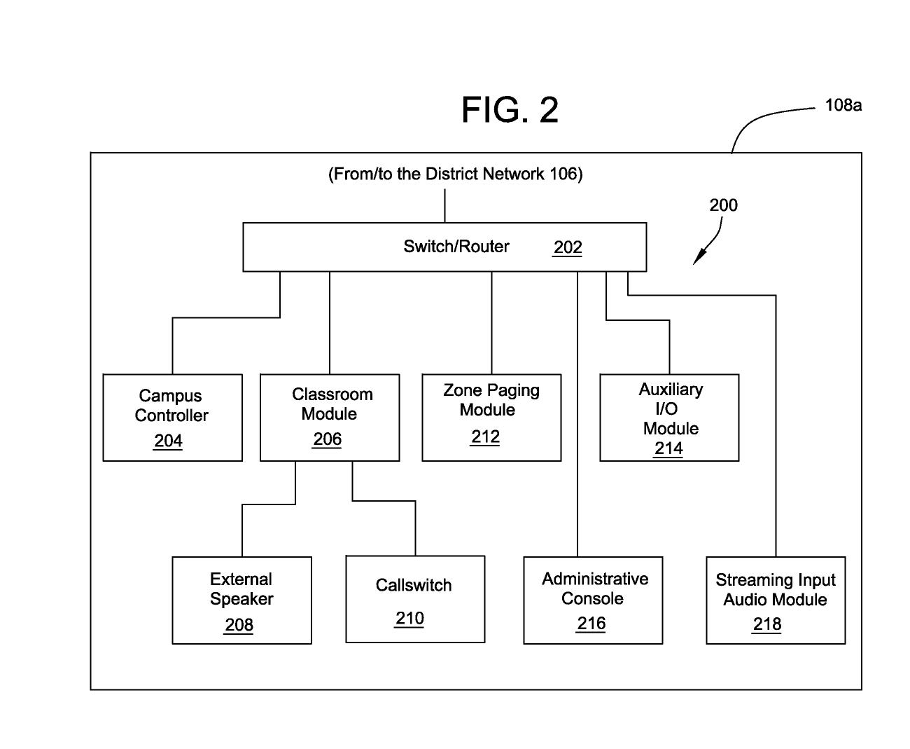

In certain embodiments, the district datacenter 102 further includes an integrated computer terminal that hosts a microphone 112. The microphone 112 is configured to allow a user to provide audio to the microphone 112, which can be streamed to any intercom system at any campus 108a, 108b or 108c within the district. As an aside, each individual school intercom system (see FIG. 2) can also include an integrated computer terminal that hosts a microphone client into which a microphone can be integrated such that an audio signal from the microphone can be broadcast over the school intercom system.

FIG. 2 illustrates the components of the school intercom system 200 for individual school campus 108a. The school intercom system 200 includes a switch/router 202, which provides a shared network connection for the various components of the school intercom system 200 to the district network 106 (see FIG. 1). The various components of the school intercom system 200 are distributed throughout a plurality of zones, which define physical spaces within the district location or in other words the school campus 108a. In this regard, each zone has zone specific intercom equipment associated with the district location/school campus 108a.

Components of the school intercom system 200 include a campus controller 204, a room or classroom module 206, and a zone paging module 212, an auxiliary Input/Output (I/O) module 214 and an administrative console 216. The campus controller 204 is an embedded interface for all of the campus devices located at the campus 108a to the district datacenter 102 (see FIG. 1). In this regard, the campus controller 204 functions to provide the interface for the classroom module 206, the streaming audio input module 218, the zone paging module 212, the auxiliary I/O module 214 and the administrative console 216 to the district datacenter 102. The campus controller 204 functions as a Session Initiation Protocol (SIP) Gateway, including processors and memory devices that enable the campus controller 204 to provide communication to/with various intercom equipment or in other words the campus devices, including the classroom module 206, the streaming audio input module 218, the zone paging module 212, the auxiliary I/O module 214 and the administrative console 216. In this regard, the campus controller 204 functions to provide full paging, pre-recorded audio, live audio, intercom audio, and other control signals to any single campus device or combination of campus devices located within any number of zones throughout the campus 108a. Typically, the campus controller 204 interprets instructions received from the district datacenter 102 (see FIG. 1) by parsing those instructions to determine embedded intercom events. The campus controller then optionally stores/archives those instructions with an associated memory (not illustrated), transmits the instructions in the form of a control signal to various campus devices.

The campus controller 204 is capable of operating in a local mode such that it operates independently from the district datacenter 102 (see FIG. 1) for certain periods of time. For instance, in certain embodiments, the campus controller 204 may be able to maintain paging functionality, place intercom calls, provide SIP interface connectivity, maintain an audible bell schedule(s) and provide local emergency notification for certain periods of time without communication with the district datacenter 102. In certain embodiments, this time period may be as long as 48 hours. In this regard, if the campus controller 204 were disconnected from the district datacenter 102 during an emergency situation, the intercom system functionality at the campus 108a would still be provided.

The campus controller 204 includes several other features. One such feature is that it is configurable to access an external phone system through a Session Initiation Protocol (SIP) Gateway. Another feature the campus controller 204 provides are area status and configuration indicators, which allow a user to log into the user interface and clearly see what campus devices are operational and what devices are not operational for the campus associated with the specific campus controller 204. The campus controller 204 further provides encryption for all control messages communicated from the campus controller 204.

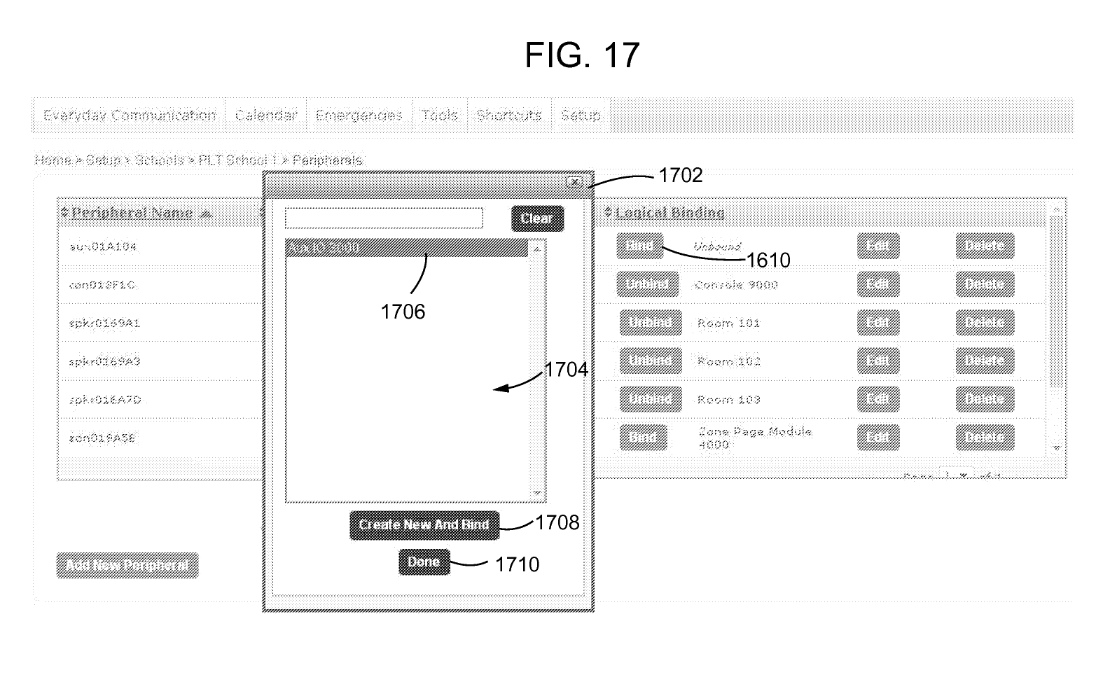

The school intercom system 200 further includes the classroom module 206 in each classroom of the school at campus 108a (see FIG. 1). In certain embodiments, each classroom can be considered a separate zone within the campus 108a. The classroom module 206 communicates via IP-based signals and interfaces with the campus controller 204 through the switch/router 202 such that it sends/receives data to/from the campus controller 204. In other words, the classroom module 206 functions as an IP room module. The classroom module 206 interfaces with a speaker 208 and one or more switches or buttons such as a check-in or call switch 210 over relay connections. In certain embodiments, the speaker 208 interfaces with the classroom module 206 through a bi-directional amplifier (not illustrated) which allows for the speaker module 208 to function as both a speaker and a microphone for the classroom module 206. Typically, communication will be between the classroom module 206 and the administrative console 216 or an external phone system and is controlled by the campus controller 204. The call switch 210 allows for personnel within the classroom containing the classroom module 206 to call into the administrative console 216 or perform a check-in during an emergency situation (discussed subsequently in relation to FIG. 17). The classroom module 206 can also trigger a visual indicator such as a strobe light (not illustrated) whenever a high priority audio signal is present. In certain embodiments, the classroom module 206 will be configured with more than one relay connection such that it can perform additional functionality. For instance, the classroom module 206 may also be configured to actuate a strobe or alert light, which would be connected to the classroom module 206 over one of the relay connections. The classroom module 206 would activate the alert light upon receiving a command to do so from the campus controller 204.

School intercom system 200 further includes the zone paging module 212. Typically, a school will include a plurality of zones, which comprises various locations throughout the school and campus in general. Typically, each non-classroom zone within the school will include at least one zone paging module 212. The zone paging module 212 decodes IP-based audio signals from the campus controller 204 into analog audio signals for local playback by an associated speaker (not illustrated). The zone page module 212 includes at least one relay connection, which allows the zone page module 212 to communicate with external devices such as the associated amplifier of the associated speaker(s). In certain embodiments, the zone page module 212 will be configured with more than one relay connection such that it can perform additional functionality. For instance, the zone page module 212 may also be configured to actuate a strobe or alert light, which would be connected to the zone page module 212 over one of the relay connections. The zone page module 212 would activate the alert light upon receiving a command from to do so from the campus controller 204.

The school intercom system 200 further may include one or more auxiliary I/O modules 214. The auxiliary I/O module 214 includes two relay outputs and two switch inputs. The relay outputs are configurable to control devices associated with the auxiliary I/O module 214. The auxiliary I/O module 214 receives IP based messages from the campus controller 204 and decodes those messages such that it can perform various system functions via the two relay outputs. For instance, one of the relay outputs may be connected to an alert light or strobe light, and the other relay output may be connected to a door latch of a door associated with the auxiliary I/O module 214. In this regard, during an emergency situation, the auxiliary I/O module 214 can be utilized to activate the alert/strobe light and lock or unlock the door.

Further, the auxiliary I/O module 214 transmits IP based messages to the campus controller 204 from the switch inputs. The switch inputs function as general purpose switch inputs configured to receive data from external devices such as a panic button or a security camera. The panic button allows personnel within the school to trigger an emergency event upon actuation of the panic button. Upon actuation of the panic button, the auxiliary I/O module will transmit data to the campus controller 204 that an emergency event is occurring, and the campus controller 204 will trigger an emergency event (discussed subsequently in relation to FIG. 17).

The school intercom system 200 further includes the administrative console 216, which, in certain embodiments, provides a single point of access to the school intercom system 200. In this regard, the administrative console 216 is equipped with various interfaces, speakers and microphones for effecting communication within the school intercom system 200. The administrative console 216 can initiate classroom intercom discussion over the classroom module 206, perform zone or system-wide pages and receive visual alerts from classroom communications over a display associated with the administrative console 216. In certain embodiments, the administrative console 216 can also perform pre-programmed sequences for the school intercom system 200, such as initiating an emergency sequence (discussed subsequently in relation to FIG. 17).

As mentioned above, the administrative console 216 includes an associated display. In certain embodiments, during an emergency event, the display can be configured to function as a centralized emergency console or in other words an emergency display console that can display check-in information for each zone or classroom within the school campus 108a (see FIG. 1). Check-in information indicates that a classroom has checked in by pressing the call switch 210 during the emergency event and thereby indicates that the particular classroom associated with that call switch 210 is not in an immediate emergency. In this regard, first responders to an emergency situation will have a single point where immediate status of the various classrooms and zone within the school campus 108a. As an aside, the administrative console 216 is not required to also be the centralized emergency console as well. A separate device similar to the administrative console 216 could be utilized as a dedicated device to function as an emergency console only during emergency events.

Further, during an emergency situation, the administrative console 216 or any similar dedicated device is further functional to listen in to various classrooms over the speaker 208. Typically, in a non-emergency situation, when the administrative console 216 initiates communication with a classroom module 206 a preannounce tone is played to indicate the classroom to the incoming message, and at fixed timer intervals a supervisory tone is played to indicate the classroom remains in audio communication. However, during an emergency, the administrative console 216 can be configured to retrieve audio data from the speaker 208 but not play the preannounce or supervisory tone such that any individual within that particular classroom will be unaware that the audio within that classroom is being sent to a speaker associated with the administrative console 216. This is a stealth mode of operation.

The stealth mode of operation can be selectively turned on or off via the administrative console 216 or any similar dedicated device or the web-based user interface running on user computer 110 (see FIG. 1). To turn the stealth mode of communication on or off, the administrative console 216 or any similar dedicated device or the web-based user interface running on user computer 110 instructs the campus controller 204 to either cause the preannounce or supervisory tones be played or not be played. The stealth mode of operation can be selectively turned on or off across the whole intercom system 200 or by individual zones or groups of zones, including individual rooms and groups of rooms within the school campus 108a.

The school intercom system further may include the streaming audio input module 218. The streaming audio input module is an IP based embedded device of the campus controller 204 with a line level audio input. The line level audio input is functional to rebroadcast audio injected into the input to other systems/devices on the switch/router 202 as a multicast stream, and, in certain embodiments, is controllable via the web-based user interface. In other embodiments, the rebroadcasted audio is streamed onto all devices on the switch/router 202. Additionally, in certain embodiments, the streaming audio input module 218 has one or more LEDs indicating that an audio broadcast is active. Also, in certain embodiments, the streaming audio input module 218 will only play the rebroadcasted audio at devices connected to switch/router 202; however, in other embodiments, the campus controller 204 is configured to provide the rebroadcasted audio to other campus controllers from other school intercom systems located at other campuses within the district, such as campuses 108b and 108c (see FIG. 1).

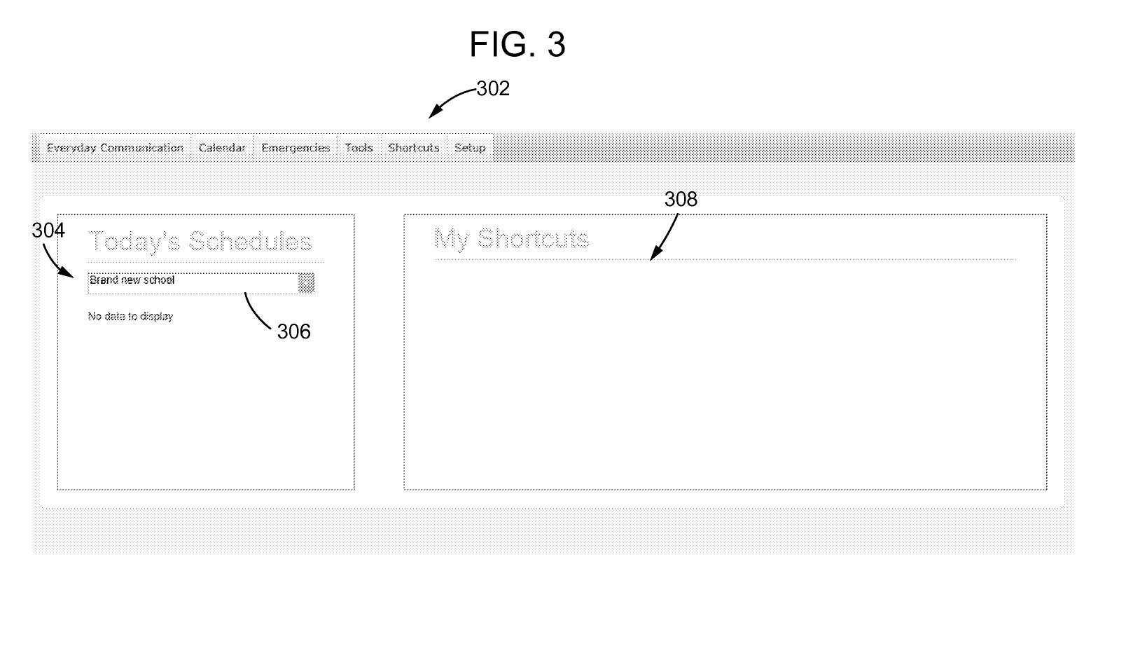

Turning now to configuration and administrative control of the intercom system 200, as mentioned above, an administrator can configure the intercom system of an individual or the plurality of campuses 104 (see FIG. 1) via the web-based user interface. FIGS. 3-15 provide various views of the web-based user interface and its associated functionality. FIG. 3 illustrates a typical screen a user will see upon providing login credentials to access the user interface. Upon logging in, the user is presented with box 304 containing currently-running schedules for the various schools the particular user's access credentials give access to. The schools are selectable from drop down box 306. If a school is selected by the user in the drop down box 306, then the space below the drop down box 306 will be populated with currently-running schedule data for that particular school. The user also has access to saved short cuts, which allow a user to create links to specific frequently-repeated user interface functions for specific schools. The user's shortcuts will be saved in the My Shortcuts box 308.

FIG. 3 further illustrates the access bar 302, which allows the user to access the various control and setup screens of the user interface. The access bar 302 includes options for “Everyday Communication,” “Calendar,” “Emergencies,” “Tools,” “Shortcuts” and “Setup.” By selecting of these options from the access bar 302, the user will be presented with further sub-options providing varying level of control over the school intercom systems the user has been granted access to.

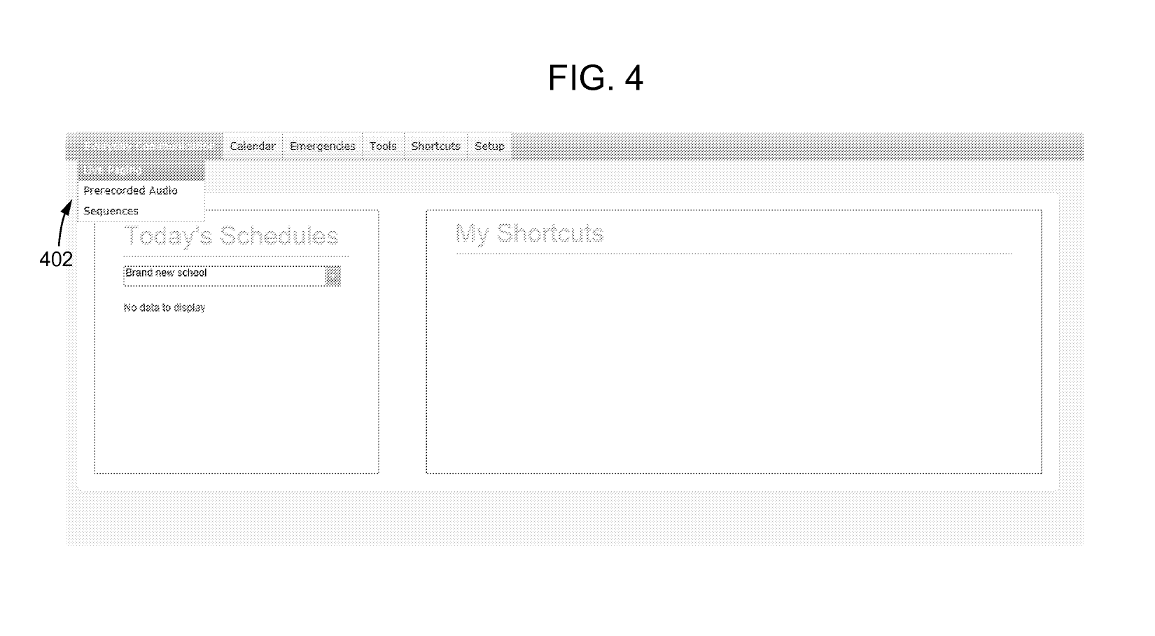

FIG. 4 illustrates sub-options 402 available upon a user selecting the above mentioned “Everyday Communication” option from the access bar 302. Sub-options 402 include an option to access separate user interface screens for “Live Paging,” “Prerecorded Audio” and “Sequences.”

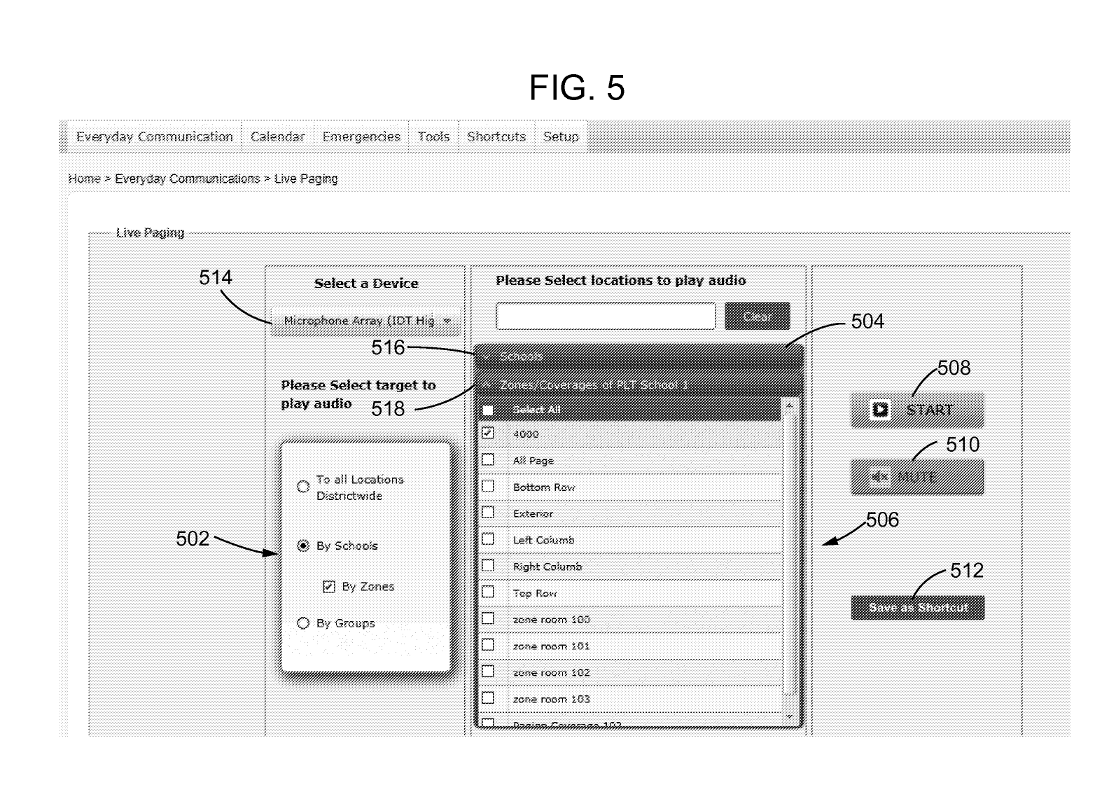

FIGS. 5-7 illustrate the various screens accessed upon selecting one of the sub-options 402. FIG. 5 illustrates the user interface screen for “Live Paging,” which functions to send audio from the user computer system 110 (see FIG. 1) to any room or zone within any school within the district. Under the “Live Paging” sub-option, a user must first select a device for the live paging audio source from the drop down box 514. In the illustrated embodiment, a microphone array has been selected. After selecting the live page audio source, the user must then select which of the devices within the district should receive the live page by selecting an option within the target selection box 502. Box 502 includes an option to send the live page to “all Locations Districtwide,” which will send the page to all of the school campuses within the district. Box 502 further includes an option to send the live page “By Schools” with a further sub-option to specify “By Zones” within that school. Also, Box 502 further includes an option to send the live page “By Groups,” which allows the user to select a group of specific schools representing a pre-configured sub-set of all schools in the district to receive the live page.

FIG. 5 further illustrates a box 504 that presents the user with options on where to send the live page based on the selection made in box 502. In the illustrated embodiment, the user has selected to send the live page to certain zones within a school. In this regard, box 504 displays a drop down box 518 to select a school and a drop down box 518 to display selectable zones within the selected school. Also, illustrated are start box 508, which allows the user to start the live page; mute box 510, which allows the user to mute the live page locally; and a save as shortcut box 512 such that the user can save this specific set of selected live page options as a shortcut for later use.

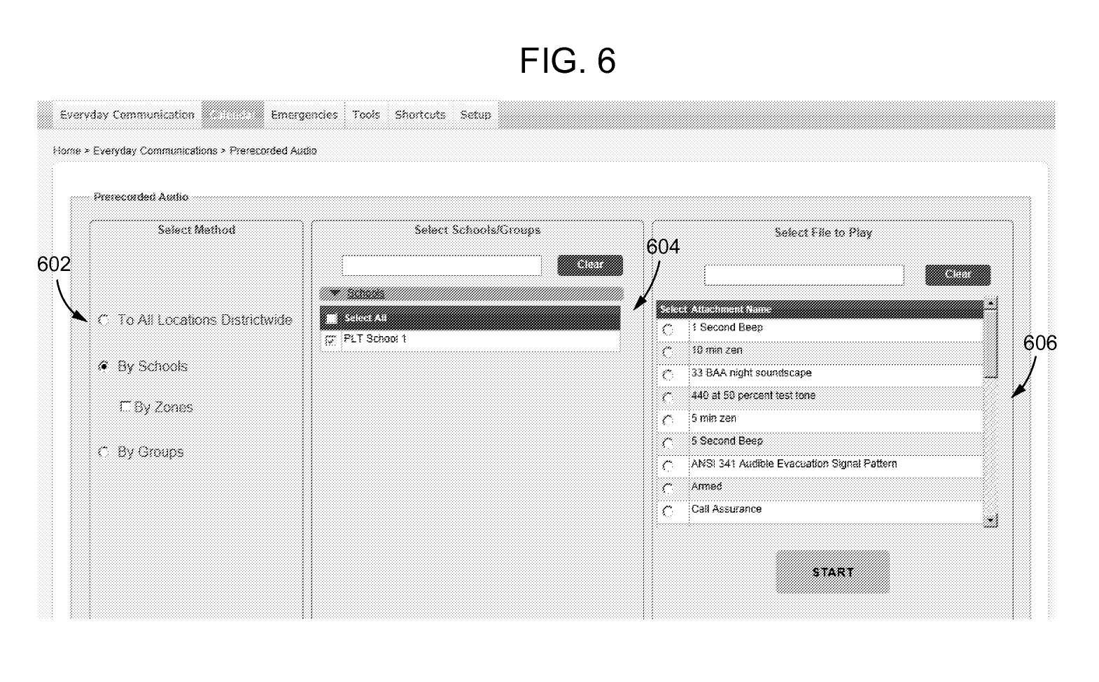

FIG. 6 illustrates a user interface screen displayed upon selecting the “Prerecorded Audio” sub-option under the “Everyday Communication” option from the access bar 302 (see FIG. 3). Prerecorded audio plays a stored audio file at any zone or classroom within any school within the district. Similar to the target selection box 502 (see FIG. 5), the user is presented with a “Select Method” box 602 that allows the user to select where the prerecorded audio should be played. Box 602 includes an option to send the prerecorded audio to “all Locations Districtwide,” which will send the prerecorded audio to all of the school campuses within the district. Box 602 further includes an option to send the prerecorded audio “By Schools” with a further sub-option to specify “By Zones” within that school. Also, Box 602 further includes an option to send the prerecorded audio “By Groups,” which allows the user to select a group of specific schools representing a pre-configured sub-set of all schools in the district to receive the prerecorded audio.

FIG. 6 further illustrates box 604, which functions to allow the user to select specific schools or groups of schools based on the selection in box 602. In the illustrated embodiment, FIG. 6 shows that a school “PLT School 1” has been selected. After selecting a target school for the prerecorded audio, the user is able to select the actual prerecorded audio file to play in box 606.

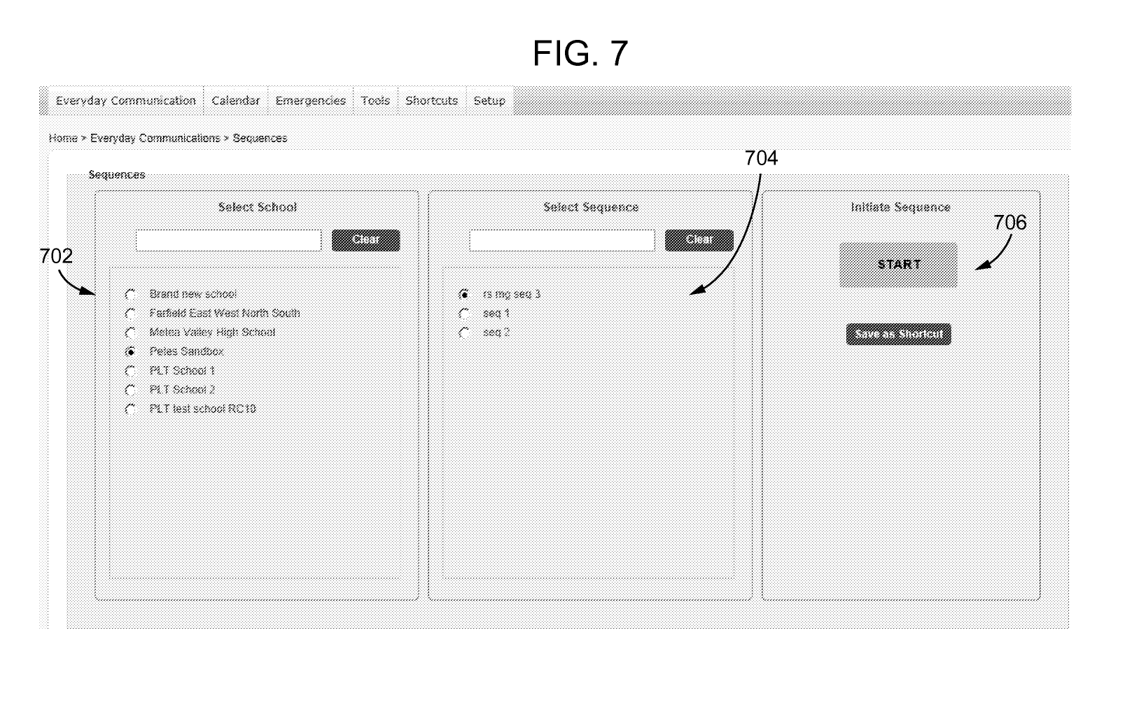

FIG. 7 illustrates a user interface screen displayed upon selecting the “Sequences” sub-option under the “Everyday Communication” option from the access bar 302 (see FIG. 3). A sequence is a predefined set of intercom events that includes a set of user-defined steps for a school intercom system to perform. For instance, a sequence could be defined to play prerecorded audio to certain subsets of classrooms or zones within a specific school and then unlock one or more doors and turn one or more lights on or off. After defining the sequence, the user would then give that particular sequence a name and store it in the system such that it can be selected at later date to run within a particular school intercom system within the district.

FIG. 7 further illustrates “Select School” box 702, “Select Sequence” box 704 and “Initiate Sequence” box 706. “Select School” box 702 allows the user to select a school within the district. “Select Sequence” box 704 provides a list of previously created and stored sequences and allows the user to select one of these sequences. “Initiate Sequence” box 706 allows the user to start the sequence or save the currently selected sequence initiation options as a shortcut.

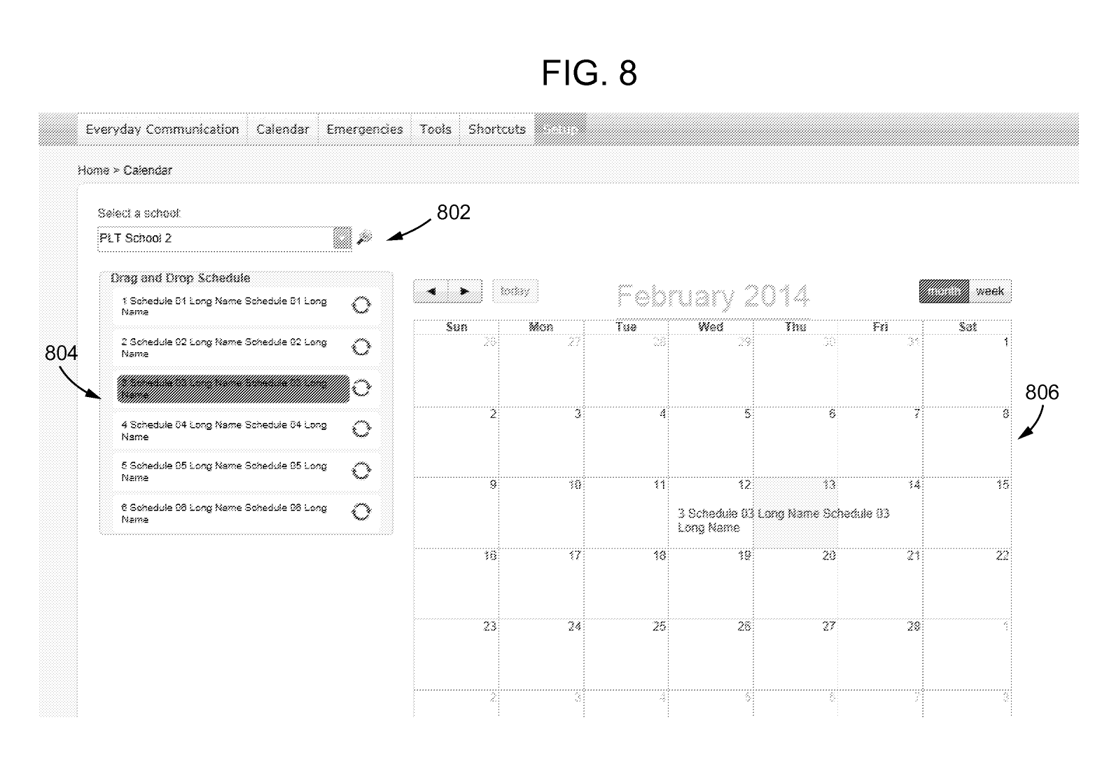

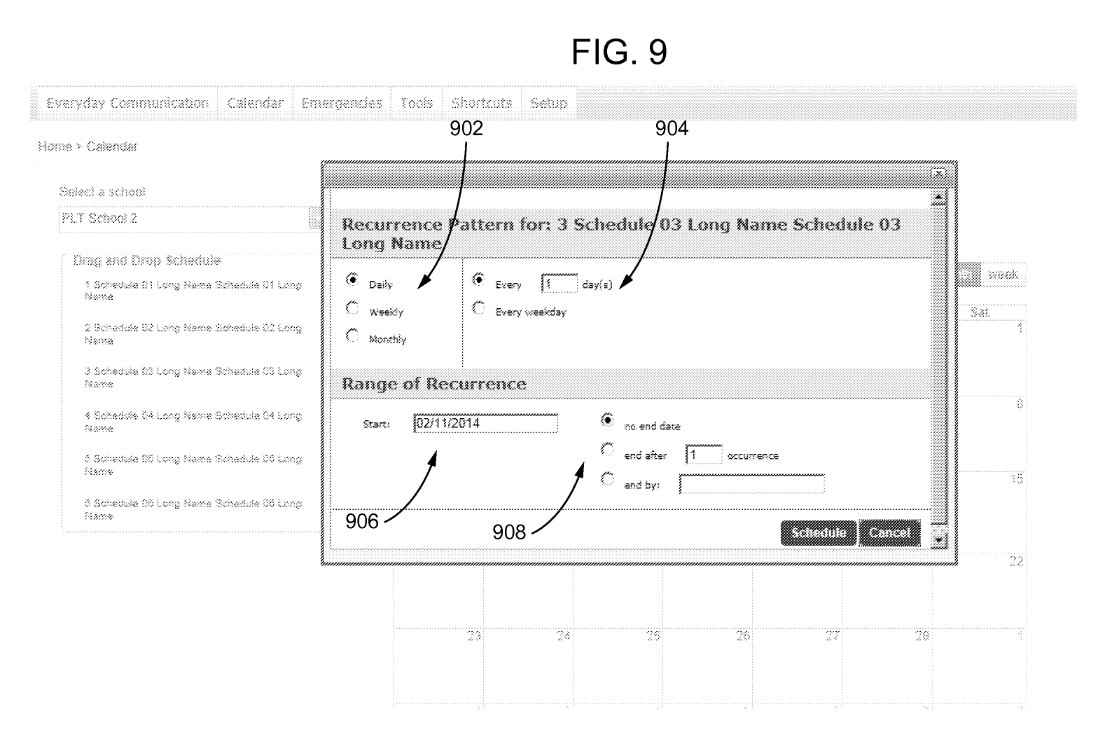

FIG. 8 illustrates the user interface upon selection of the Calendar option from the access bar 302 (see FIG. 3). Utilizing the calendar option, the user can access the scheduled intercom events for the intercom system for each school they have access to within the district. Typically, the scheduled events will be bell events and turning lights on and off during the day. The user can select a school from drop down box 802 and a Schedule from the “Drag and Drop Schedule” box 804 by selecting and dragging the Schedule to a specific day in the calendar 806. FIG. 9 illustrates a sub-screen that pops up upon dropping a Schedule to a specific day in the calendar 806. The sub-screen of FIG. 9 provides the user with options for making the Schedule a recurring assignment. Selection box 902 provides an option to have the Schedule assignment repeat on a daily, weekly or monthly basis. Selection box 904 allows the user to specify the frequency of the Schedule assignment based on the selection made in box 902. For instance, in the illustrated embodiment, because the user selected the recurrence on a daily basis in box 902, box 904 allows the user to specify the number of days between occurrences and an option to specify that the occurrence should happen each weekday. If the user selected the weekly or monthly options in box 902, then box 904 would allow the user to select a frequency of weeks or months.

FIG. 9 further illustrates a start date box 906 and an end date selection box 908. Providing information to box 906 and 908 allow a user to specify exact dates from when the Schedule assignment should start and when it should stop. The start date box 906 only requires an initial start date; however, the stop date selection box 908 provides options to have the Schedule assignment occur repeatedly with no end date, or specify a specific number of occurrences the Schedule should run prior to stopping, or a specific end date upon which the Schedule assignment will stop.

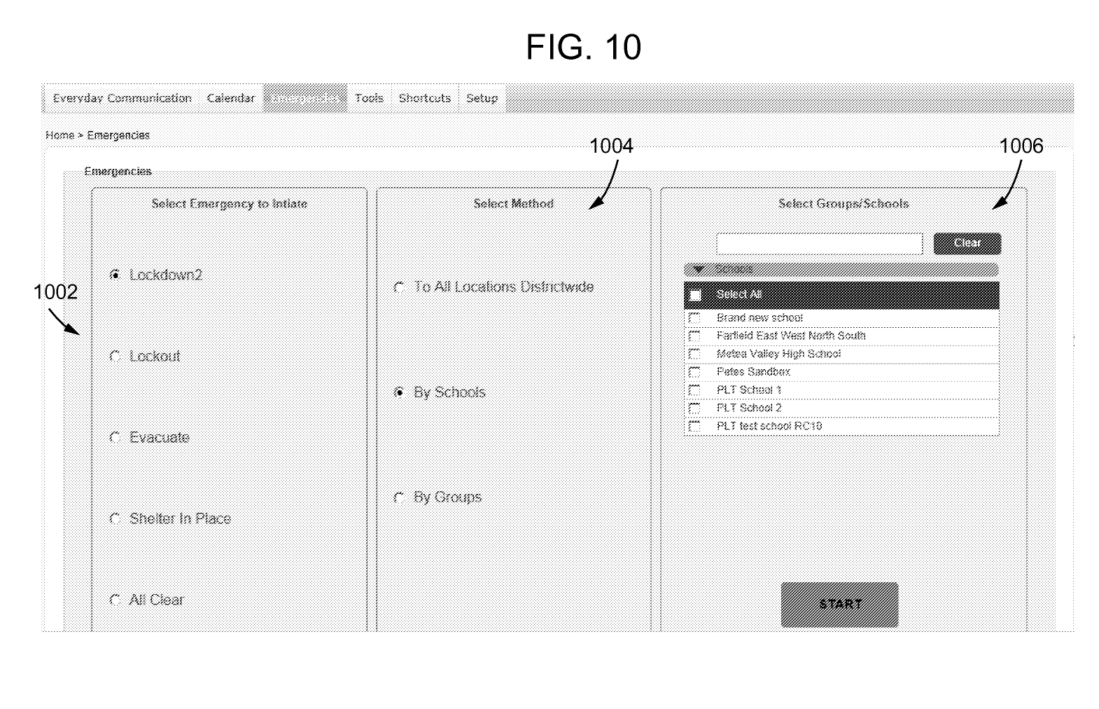

FIG. 10 illustrates the user interface upon selection of the Emergencies option from the access bar 302 (see FIG. 3). Upon selection of the Emergencies option, the user is able to select a type of emergency event to select in selection box 1002, a category of locations to conduct the emergency event in selection box 1004, and the specific locations for conducting the emergency event in box 1006.

Specifically, in box 1002, the user can select a specific type of emergency event such as a Lockdown event, a Lockout event, an Evacuate event, a Shelter in Place event and an All Clear event. The Lockdown and Lockout events pertain to an intruder present on a school campus. The Lockdown event pertains to the situation where the intruder is present inside the school, and the Lockout event pertains to the situation where the intruder is present on the campus but not inside the school building itself. The specific operation of the relevant school intercom system will be discussed further in regards to FIG. 17. The Evacuate event causes the school intercom system to issue an evacuate signal to a specified school campus or campuses. The Shelter in Place event causes the school intercom system to issue a notice for the individuals within the school campus to take shelter due to some impending danger, such as a tornado, hurricane, earthquake, etc. The All Clear event selection will cause the school intercom system to terminate an ongoing previously initiated emergency event.

Box 1004 allows the user to select what basis to choose the schools that user has access to within the district. The options present to the user are for issuing the emergency to all locations districtwide, by schools and by groups. If the user selects the all locations districtwide option, then the selected emergency event will start at all locations within the district. If the user selects by schools or by groups, then the user will be presented with a list of schools in box 1006 that the emergency event may potentially be started. Using this list of schools within the district, the user can select one or more schools or one ore more school groups based on whether the user selected “By Schools” or “By Groups” within box 1004. The user can then start the emergency event by clicking the “Start” button.

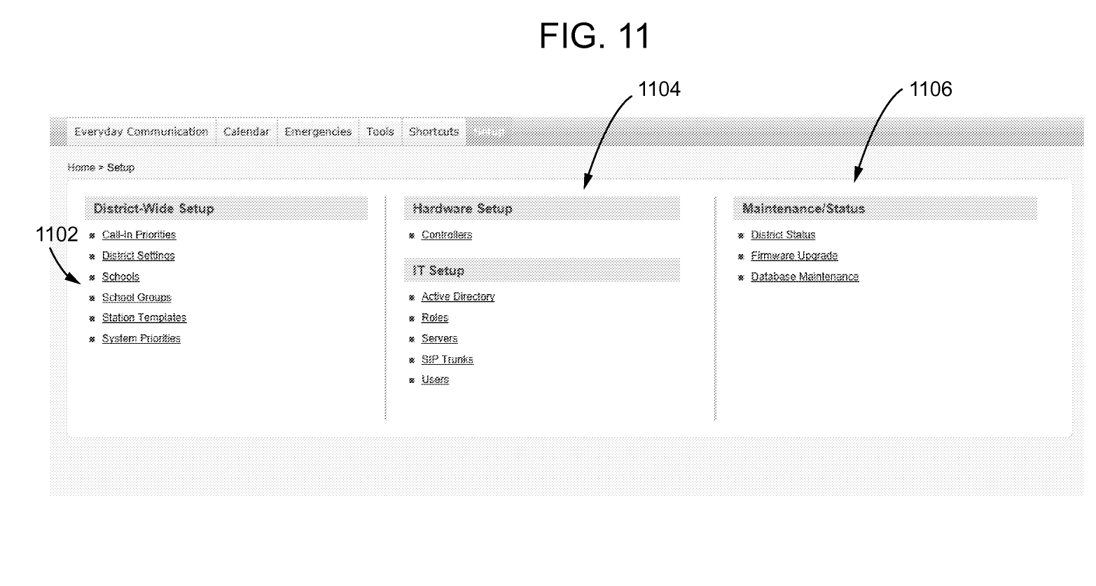

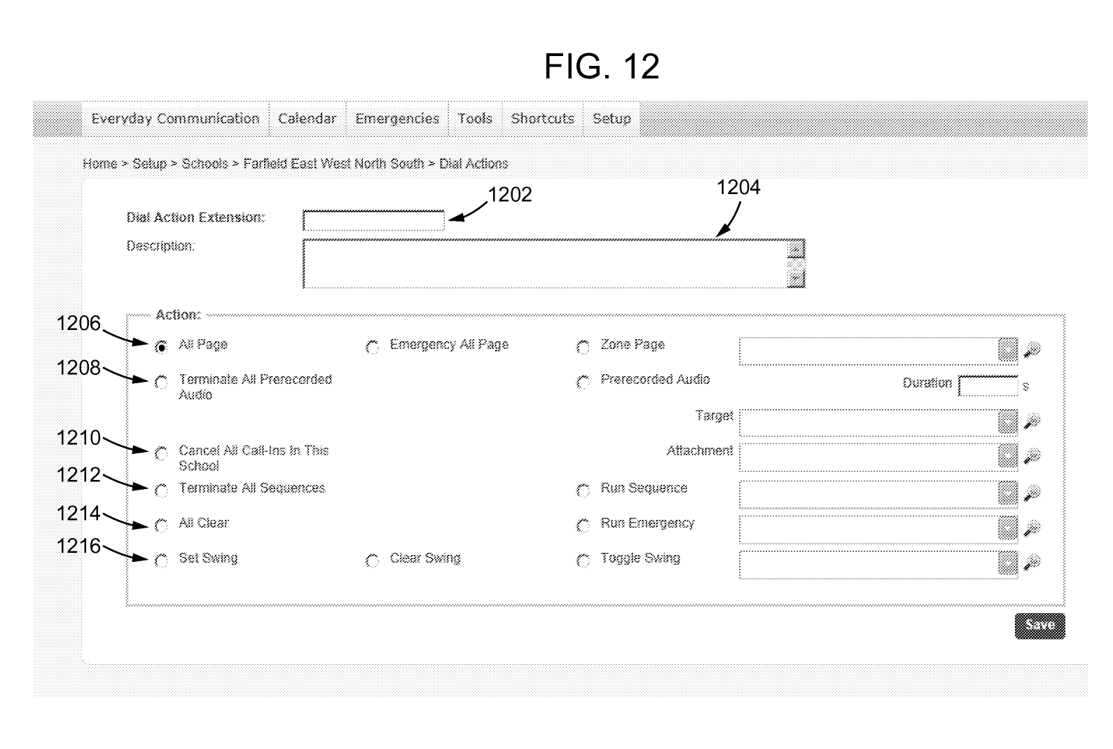

FIG. 11 illustrates the user interface upon selection of the Setup option from the access bar 302 (see FIG. 3). As illustrated, the Setup option provides the user with options for District-Wide Setup, Hardware Setup, IT Setup and Maintenance/Status. FIGS. 12-15 provide screenshots of various user interface screens accessed from the Setup option.

FIG. 12 illustrates the user interface upon selection of a specific school from under the schools link from the District-Wide Setup option of FIG. 11. Specifically, FIG. 12 illustrates a Dial Action setup screen for the specific selected school. A Dial Action lets an external phone system execute features of the selected school's intercom system by dialing a specifically defined extension. In one embodiment, upon dialing, the extension is routed to the campus controller 204 (see FIG. 2) of the selected school, which accepts the extension, hangs up on the calling user and performs the sequence or event associated with the extension. In some embodiments, the campus controller will send a confirmation back to the external phone system to confirm the sequence or event was performed.

As an aside, in certain embodiments, the external phone system is an external SIP phone system. However, in other embodiments, the external phone system may be an analog or digital phone system. In the other embodiments, an SIP Gateway will convert the received dial string from the analog or digital phone system to the SIP domain for processing by the campus controller 204.

In the illustrated embodiment, the Dial Action screen includes box 1202 that allows the user to specify an extension for the sequence or event. Box 1204 allows the user to enter a prose description of the actions performed upon dialing the extension. FIG. 12 further illustrates an Action box, which includes various options for sequences or events that can be performed upon dialing the extension. The sequences or events illustrated in the Action box represent only a single embodiment, as any number or type of Sequences or events could be represented by a selection within the Action box.

The Action box of FIG. 12 contains a selection 1206, which allows the user to initiate a page such as an All Page, an Emergency All Page or a Zone Page along with a search box for indicating which zones to play the page. If one of the selections from 1206 is made, upon dialing the extension, the campus controller 204 (see FIG. 2) will not hang up on the SIP phone that dialed the extension; rather, the user will be able to perform the page through the SIP phone.

The Action box of FIG. 12 further contains a selection 1208, which allows the user to specify that the dialed extension will either Terminate All Prerecorded Audio or play Prerecorded Audio. The user will also be able to specify a duration for the prerecorded audio to play or to be terminated. The user can also specify a target school or zone for this action to be performed. Also, if the user selects to play prerecorded audio, then the user can select an attachment file to be played.

The Action box of FIG. 12 further contains a selection 1210, which allows a user to select that the dialed extension will cause a Cancel All Call-ins In This School. This will merely cancel all currently active Call-ins in the school.

The Action box of FIG. 12 further contains a selection 1212, which allows a user to select that the dialed extension Terminate All Sequences or causes a Run Sequence. If the user selects to run a sequence upon dialing the extension, then the user can also indicate a specific sequence in the associated search box.

The Action box of FIG. 12 further contains a selection 1214, which allows a user to select that the dialed extension issue an All Clear or causes a Run Emergency. If the user selects to run an emergency upon dialing the extension, then the user can also indicate a specific emergency in the associated search box.

The Action box of FIG. 12 further contains a selection 1216, which allows a user to select that the dialed extension sets a swing, clears a swing or toggles a swing. The user is further provided with a search box to search for the system event to associate with the swing.

As an aside, a swing is a conditional statement associated with any event being performed within the school intercom system. If the swing is true, then the event associated with the swing will be performed, and if the swing is false, then the event will not be performed. In a certain embodiment, the swing can be a one bit field associated with the system message causing the event to occur in the school intercom system. If the bit is a 1, then the event is performed, and if the bit is a 0 then the event is not performed. The swing allows the user another level of tuning for specifying what rooms and zones within schools to perform the associated event. Further, a swing is not exclusively set by a dial action. A swing can be set in the user interface at various locations including in the Calendar option of the access bar 302 (see FIG. 3), by a system button associated with the administrative console 216 or the call switch 210 or the auxiliary I/O module 214 (see FIG. 2).

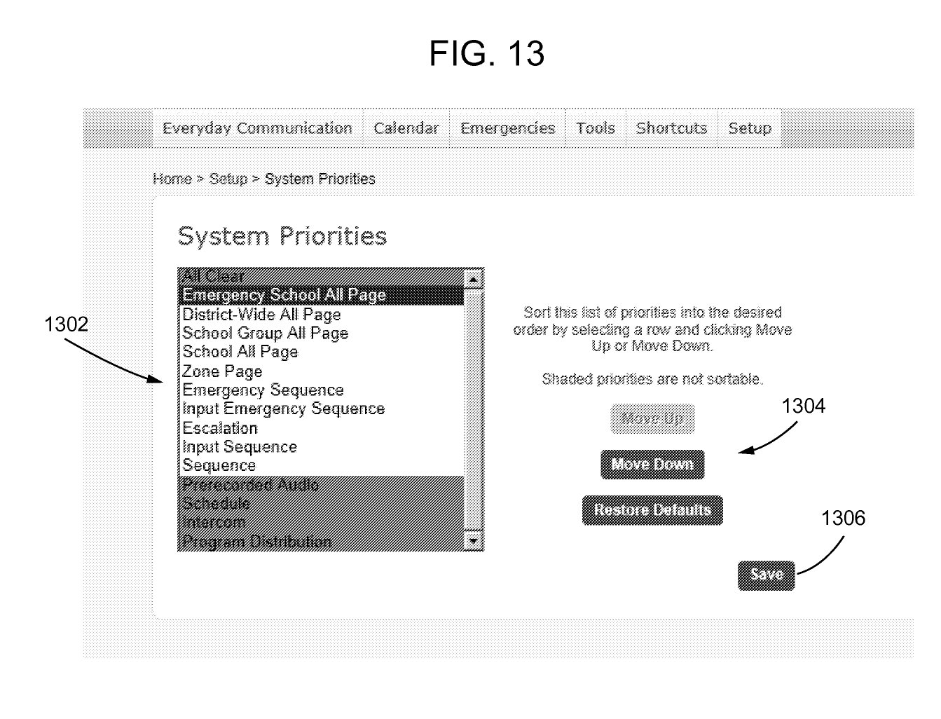

FIG. 13 illustrates a System Priorities screen of the user interface accessed from the Setup option of the access bar 302 (see FIG. 3). The System Priorities screen contains a scroll box 1302 with a list of intercom system events. The events listed in box 1302 can be moved up or down in priority by highlighting one of the events and then choosing one of the Move Up or Move Down buttons from button options 1304. Button options 1304 further includes a Restore Defaults option, which restores a default priority for listed events. The user can save any change to priorities by clicking save button 1306. The priority list in box 1302 allows the school intercom system to determine which event takes priority when two or more events occur at the same time.

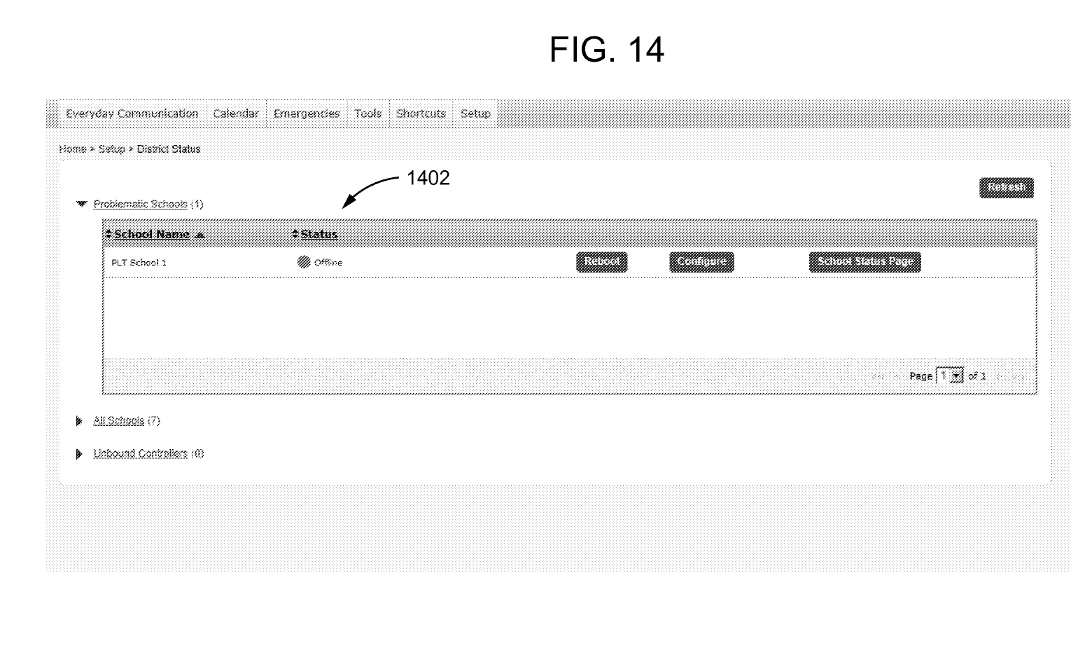

FIG. 14 illustrates a District Status screen of the user interface accessed from the Setup option of the access bar 302 (see FIG. 3). The District Status screen will list all schools and indicate any school that is currently experiencing a problem. For instance, in the illustrated embodiment, school PLT School 1 is shown as offline.

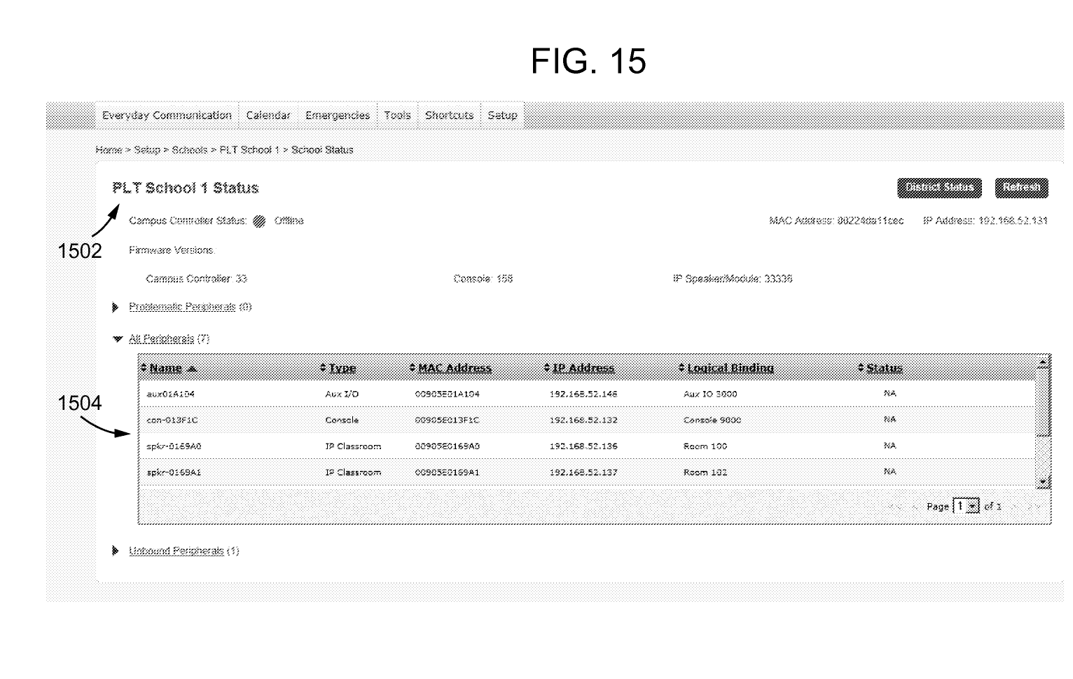

FIG. 15 illustrates a School Status, which can be accessed through the user interface either by navigating through the Setup option of the access bar 302 (see FIG. 3) or by clicking on any school listed in the District Status screen (see FIG. 14). In the illustrated embodiment, status of school PLT School 1 is shown. The status indicates that this school is currently offline. The status screen provides a list 1504 of all peripheral devices associated with the PLT School 1 intercom system. The list 1504 provides the name of the device, the type of device, a Media Access Control (MAC) address of the device, an Internet Protocol (IP) address of the device, a logical binding of the device and a status. When setting up peripheral devices within a school intercom system of a school such as PLT School 1, in the illustrated embodiment, the user can enter the name of the peripheral device to add, specify the type of device, the MAC address, the IP address, and the logical binding prior to physically installing the device into the school intercom system. Upon integration of the peripheral device into the school intercom system, the device will be auto discovered and bound based on the entries provided in list 1504 for that device.

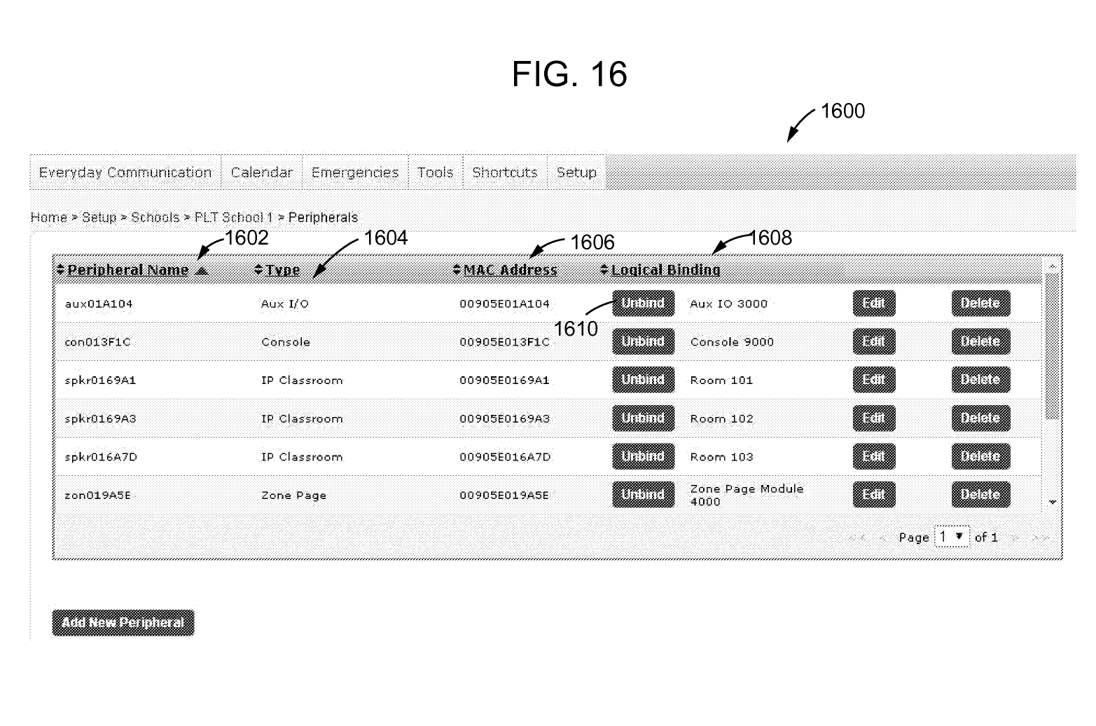

Alternatively, as illustrated in FIGS. 16 and 17, a device which has had no user provided MAC or IP address entered can be automatically discovered when connected to the switch/router 202 of the school intercom system 200 (see FIG. 2). FIG. 16 illustrates a setup for auto discovery of devices integrated into school intercom system 200. After connecting the devices to the switch/router 202, the school intercom system 200 will automatically discover certain device properties, such as the MAC address 1606, an IP address (not illustrated), and a device type 1604 of the device, and automatically create entries of these properties. At a later time a user is then able to manually create a logical binding 1608 for the device without having to enter these auto discovered properties.

FIG. 17 illustrates a setup screen 1700 for the user to provide the logical binding 1608. To access this setup screen 1700, the user will select button 1610, which depending on whether the device has a logical binding assigned or not will read either Bind or Unbind. As illustrated in FIG. 16, the devices have already had a logical binding assigned. Therefore, button 1610 reads Unbind. However, in FIG. 17, button 1610 reads Bind because certain devices have not yet had a logical binding assigned. Upon selecting button 1610 when it reads Bind, popup screen 1702 appears, which allows a user to select a logical binding 1706 from a list 1704 of potential devices within the school intercom system 200. As illustrated, the list 1704 only includes a single device; however, in other embodiments several devices may be listed. Once a user selects the desired device to create the logical binding with, the user selects button 1710 labeled “Done,” which binds the device into school intercom system 200. This also assigns a device name 1602 for the device (see FIG. 16). As an aside, popup screen 1702 further includes a button 1708 labeled “Create New and Bind.” Button 1710 functions to affirm the selection of a device from the list 1704 and establish the logical binding. Button 1708 serves as an alternative that allows the creation of a new logical binding that is not currently listed as a selection option from list 1704 (because it did not previously exist) and then allow selection of the new logical binding in place of a selection from the list 1704 of existing logical bindings.

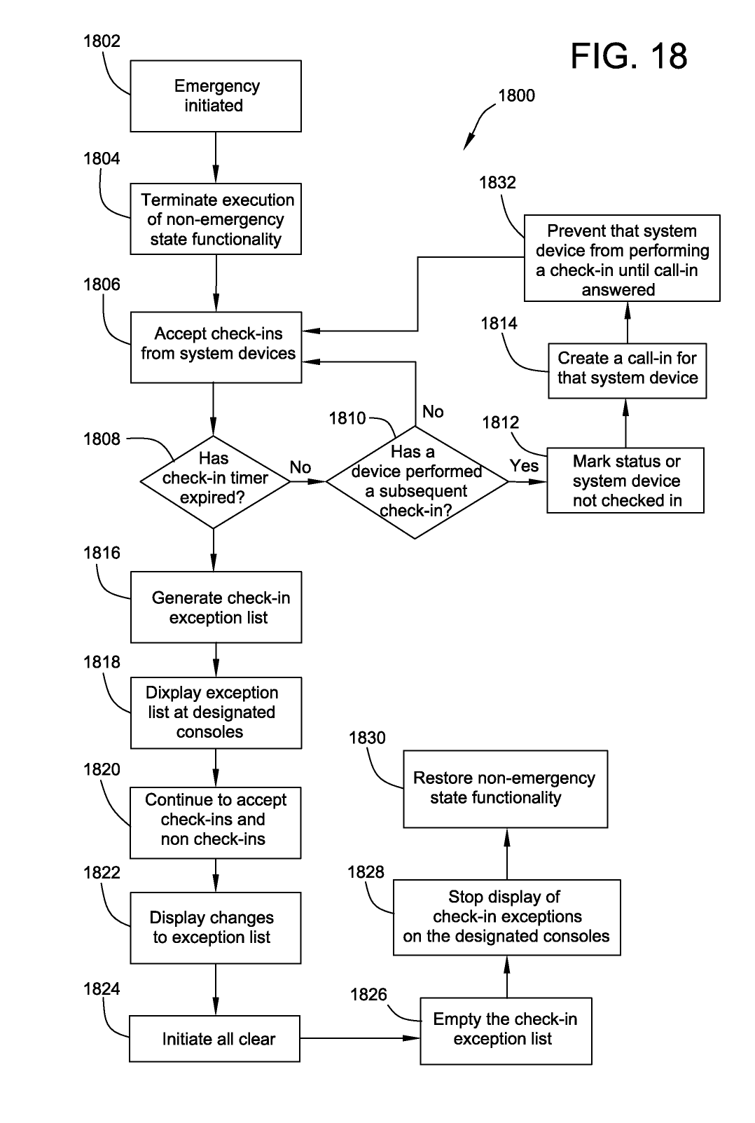

Turning to operation of the school intercom system 200 (see FIG. 2) upon initiation of certain functions, FIGS. 18-22 will be described. FIG. 18 illustrates an operational flow 1800 of a school intercom system such as school intercom system 200 upon initiation of an emergency event. At step 1802 the emergency event is initiated. The initiation can come from multiple locations throughout the school intercom system and also from the district level (illustrated in FIG. 1). For instance, in certain embodiments, the emergency event could be initiated at a switch related to the auxiliary I/O module 214, a soft key of the administrative console 216, via a dial action from an SIP phone or by a web-based user interface via the user computer system 110.

After initiation, the campus controller 204 (see FIG. 2) for each targeted school intercom system within the district where the emergency event was initiated terminates execution of non-emergency state functionality of the school intercom system at block 1804. Typically, this will cause the scheduled bell events from currently active Schedules, as shown in the calendar (see FIG. 8), from occurring during the emergency event.

At block 1804, the campus controller 204 (see FIG. 2) accepts check-ins from system devices. A check-in is an indication provided from a system device indicating that the location that particular system device is associated with is not in immediate danger. In certain embodiments, the classroom module 206 will issue a check-in if an individual within the classroom actuates the call switch 210 during an emergency event. Upon receiving a check-in from a system device, the campus controller 204 will cause an emergency event screen to indicate that a particular location has issued a check-in and is therefore not in immediate danger. The emergency event screen functions as a single location for first providers to utilize to respond to an emergency situation. In certain embodiments, a screen associated with the administrative console 218 functions as the emergency event screen.

At block 1808, the campus controller 204 (see FIG. 2) checks whether a check-in timer has expired. The check-in timer is a period of time the campus controller 204 will wait to receive a check-in message prior to indicating that a particular location associated with a system device has not issued a check-in, and therefore, that particular location may currently be in danger from the emergency.

If it is determined at block 1808 that the check-in timer has not yet expired, then at block 1810 the campus controller 204 (see FIG. 2) checks to see if an uncheck-in message has been received. As an aside, an uncheck-in message is generated when a system device issues a check-in more than once or places a call-in from a location which has previously checked in. Upon the second check-in or the call-in from a previously checked in location, the campus controller 204 will determine that the system device has issued an uncheck-in and place a post check-in emergency call-in from that particular device as a top priority on the emergency event screen thereby indicating that the particular location within the school associated with the system device is in immediate danger. While the post check-in emergency call-in persists, that classroom module 206 may not issue another check-in message. The post emergency call-in must be locally answered or canceled before that location may issue a check-in message again. If no uncheck-in message has been issued, then the campus controller 204 proceeds to keep monitoring for check-in events.

However, if an uncheck-in message is received, then at block 1812, the campus controller 204 (see FIG. 2) will mark the status of the system device issuing the uncheck-in as not checked in, and in block 1814, the campus controller 204 creates a call-in event for the system device. Also, at block 1834, the system device is prevented from performing a check in until the call-in is answered or canceled. In certain embodiments, the call-in event is a stealth mode call-in such that any audio communication established between the administrative console or SIP phone and the classroom module is not preceded by a supervisory tone. In this manner, the personnel located at the administrative console 216 or SIP phone can hear the audio within the location associated with the system device while the individuals within that location will not know that the audio is being monitored.

The campus controller 204 (see FIG. 2) will continue to accept check-ins until expiration of the timer. Upon expiration of the timer, at block 1818, the campus controller 204 will generate an exception list. The exception list is a list of locations associated with system device that have no issued check-in messages. The campus controller 204 causes the list of locations to be displayed, at block 1818, on the emergency event screen for emergency personnel to review.

At block 1820, the campus controller 204 (see FIG. 2) proceeds to still accept check-in messages from system devices, and at block 1822, the campus controller 204 causes the emergency event screen to update the exception list. Blocks 1820 and 1822 will continue to operate until, at block 1824, an all clear is initiated by the campus controller 204. An all clear is a message received that indicates the emergency event is over. Upon receiving the all clear message, the campus controller 204 will empty the exception list at block 1826, stop displaying check-in exceptions on the emergency event screen at block 1828, and at block 1830, the campus controller 204 restores non-emergency functionality.

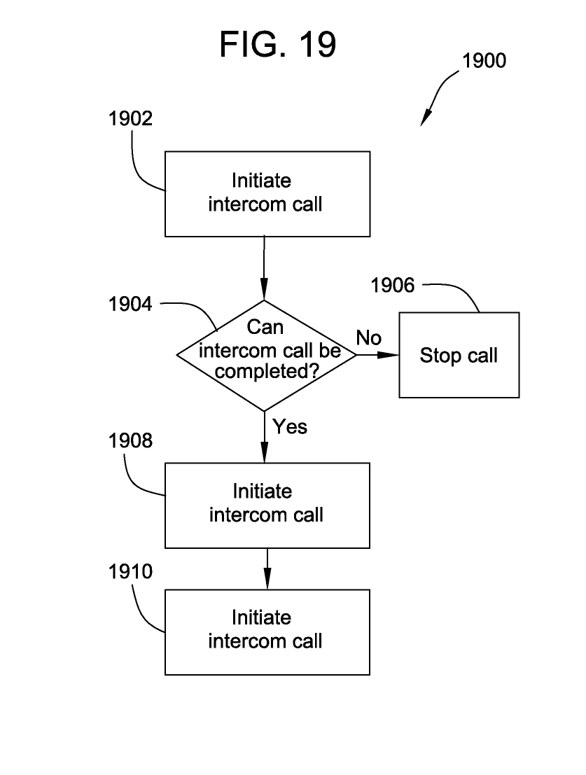

FIG. 19 illustrates a flow chart 1900 for initiating an intercom call event. Typically, this event can be initiated by either the administrative console 216 wanting to contact a specific classroom module 206, or vice versa where the classroom module 206 contacts the administrative console. The functional effect of the intercom call event is to start audio communication between the two points in the school intercom system.

In this regard, at block 1902, either the administrative console 216 (see FIG. 2) will contact one of the classroom module(s) 206 or vice versa. The contact is administered via the campus controller 204. After initiation, the campus controller 204 checks to ensure the intercom call can be completed. As such, the campus controller 204, at block 1904, checks to ensure school intercom resources are available, and checks to make sure either the classroom module 206 or the administrative console 210 is available. If the system resources are not available, the campus controller 204 terminates the intercom call event. However, if resources are available, at block 1908, the campus controller 204 initiates the intercom call. At block 1910, the intercom call can be terminated by either one of the administrative console 210 or the classroom module 206 sending a message to the campus controller 204 to terminate the intercom call.

As an aside, in certain embodiments, the intercom call will terminate upon the expiration of a fixed timer initiated at the start of the intercom call. In other embodiments, the timer starts upon initiation of the intercom call but is not fixed in the sense that the timer resets based upon a detected voice or keyboard activity.

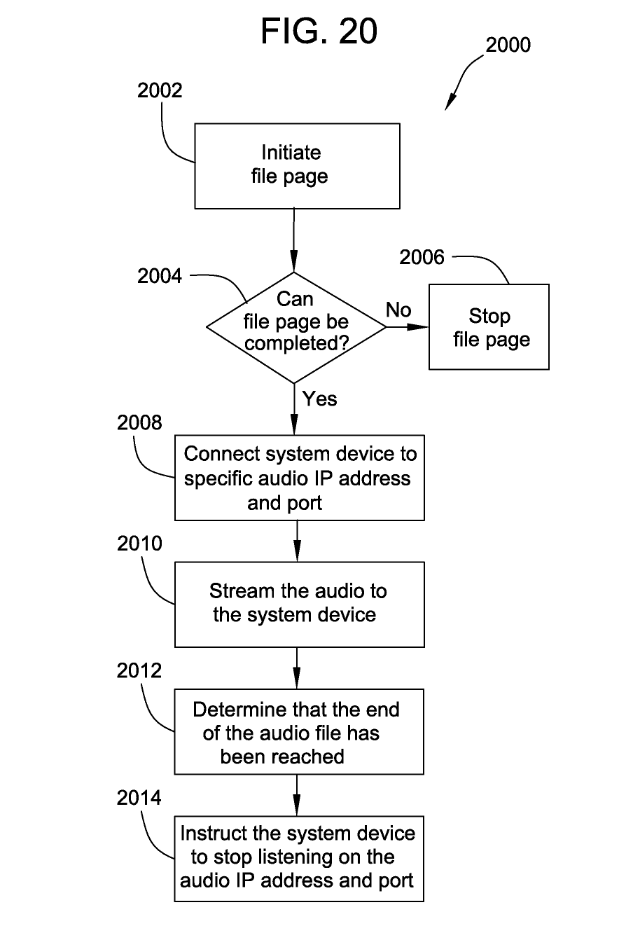

FIG. 20 illustrates a flow chart 2000 for initiating a file page. At block 2002, the file page is initiated. This initiation can occur in many ways in the school intercom system, such as being initiated by a soft key at the administrative console 210 (see FIG. 2). The file page event plays an audio file at a specified system device or device(s) within the school intercom system. For instance, the file page may be played over speaker 208 associated with the classroom module 208 or over a speaker associated with a zone page module 212 or an auxiliary I/O module 214.

In this regard, at block 2002, the administrative console 216 (see FIG. 2) will contact the campus controller 204 to initiate the file page. After initiation, the campus controller 204 checks to ensure the file page can be completed. As such, the campus controller 204, at block 2004, checks to ensure school intercom resources are available, and checks to make sure the target system device or devices are available. If the system resources are not available, the campus controller 204 terminates the intercom call event at block 2006. However, if resources are available, at block 2008, the campus controller 204 initiates the file page by instructing the specified system device(s) to connect to a specific audio IP address and port number. At block 2010, the campus controller 204 will stream the audio file over the specified IP address and port. At block 2012, the campus controller 204 determines that the audio file has ended, and at block 2004 the campus controller 204 instructs the specified system device(s) to stop listening on the previously provided IP address and port number.

As an aside, generally, within the school intercom system 200 (see FIG. 2), audio is streamed to the system device(s) over either a unicast User Datagram Protocol (UDP) port or a multicast UDP port of the classroom module 206 or the zone page module 212 or the auxiliary I/O module 214. As all devices within the school intercom system 200 (see FIG. 2) communicate over TCP/IP internet protocol suite, the file page will be communicated over a UDP port as it provides a simple connectionless transmission model with a minimum of protocol mechanisms. The unicast UDP port is utilized to send the audio file to a single system device such as a single classroom module 206 or a single zone page module 212 or single auxiliary I/O module 214. The multicast UDP port is utilized to send the audio file to multiple system devices such as multiple classroom modules 206 or multiple zone page modules 212 or multiple auxiliary I/O modules 214 within the school intercom system 200.

As a further aside, in the situation where the file page is directed to one or more auxiliary I/O module(s) 216, along with the audio file a further command to perform a physical action can be sent. For instance, a command to lock a door or turn on a light, both associated with the auxiliary I/O module 216, may be sent.

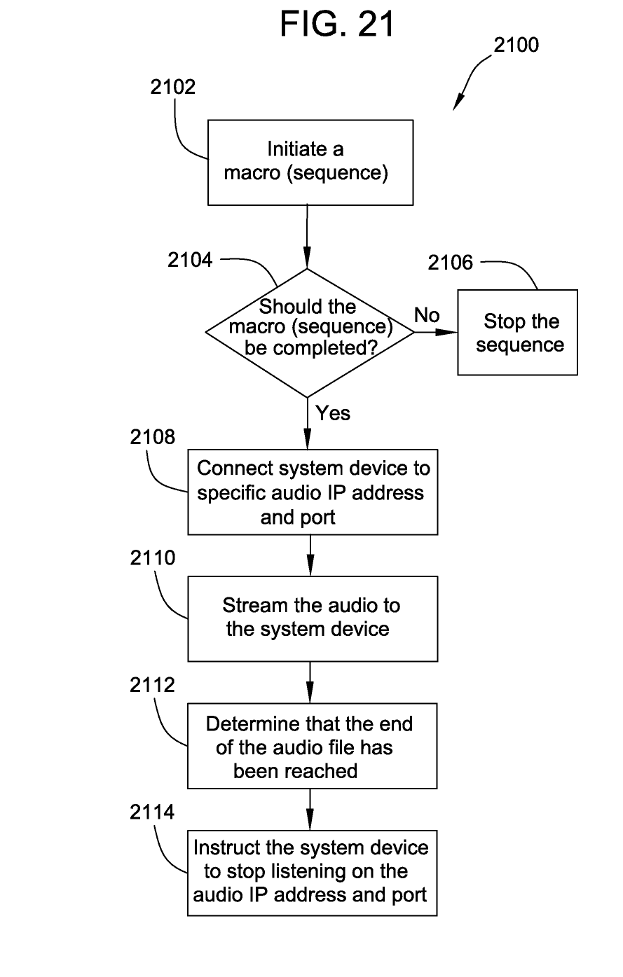

FIG. 21 illustrates a flow chart 2100 showing steps the school intercom system 200 (see FIG. 2) performs while executing a sequence. As mentioned above, a sequence is a previously defined set of system actions such as playing audio, locking doors and/or turning on or off lights via single stored sequence. The embodiment illustrated in FIG. 21 is a sequence configured to play an audio file. The sequence plays the audio file at a specified system device or device(s) within the school intercom system. For instance, the audio file may be played over speaker 208 associated with the classroom module 208 or over a speaker associated with a zone page module 212 or an auxiliary I/O module 214.

At step 2102, the sequence is initiated. The sequence can be in a variety of ways, such as via a softkey of the administrative console 216. In this regard, at block 2102, the administrative console 216 (see FIG. 2) will contact the campus controller 204 to initiate the audio sequence. After initiation, the campus controller 204 checks to ensure the sequence can be completed. As such, the campus controller 204, at block 2104, checks to ensure school intercom resources are available, and checks to make sure the target system device or devices are available. If the system resources are not available, the campus controller 204 terminates the sequence at block 2106. However, if resources are available, at block 2108, the campus controller 204 initiates the sequence by instructing the specified system device(s) to connect to a specific audio IP address and port number. At block 2110, the campus controller 204 will stream the audio file over the specified IP address and port. At block 2112, the campus controller 204 determines that the audio file has ended, and at block 2104 the campus controller 204 instructs the specified system device(s) to stop listening on the previously provided IP address and port number.

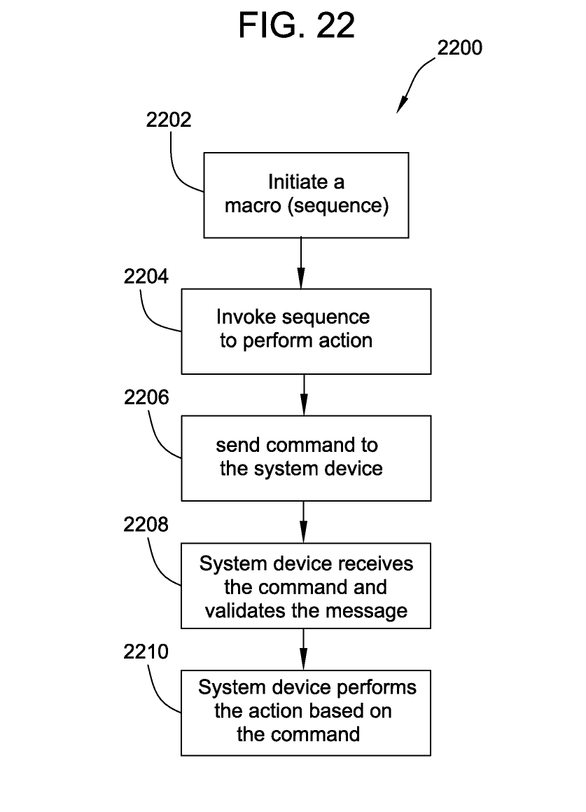

FIG. 22 illustrates a flow chart 2200 showing steps the school intercom system 200 (see FIG. 2) performs while executing a sequence. As mentioned above, a sequence is a previously defined set of system actions such as playing audio, locking doors and/or turning on or off lights via single stored sequence. The embodiment illustrated in FIG. 22 is a sequence configured to perform a non-audio action, such as locking/unlocking a door or turning a light on/off. Typically, the sequence associated with an action, such as locking/unlocking a door or turning a light on/off, will be performed by one or more auxiliary I/O module(s) 214. However, in certain embodiments, sequences could be configured that combine both audio and non-audio actions that would make use of one or more classroom module(s) 206, zone page module(s) 212 and/or auxiliary I/O module(s) 214.

At step 2202, the sequence is initiated. The sequence can be in a variety of ways, such as via a softkey of the administrative console 216 (see FIG. 2). In this regard, at block 2204, the campus controller 204 invokes the sequence to perform the action. At block 2206, the campus controller 204 sends the commands of the sequence to the system device specified in the sequence, such as the auxiliary I/O module 214. At block 2208, the system device receives the command and proceeds to send a validation message back to the campus controller 204. The campus controller 204 receives this validation message such that it knows the action was received by the specified system device and is being performed. At block 2210, the specified device performs the sequence.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A distributed intercom system, the system comprising:
a district server configured to manage at least one intercom system located within a district location managed by the district server;
a district network configured to communicatively couple the at least one intercom system and the district server; and
a web-based interface configured to allow access to the district server to control the at least one intercom system,
wherein the at least one intercom system located within the district location comprises:
a network switch configured to integrate intercom equipment associated with the district location into the at least one intercom system;
a plurality of zones where each zone of the plurality of zones defines a physical space within the district location and each zone comprises zone specific intercom equipment of the intercom equipment associated with the district location; and
a controller communicatively coupled to the network switch and configured to control the intercom equipment associated with the district location.

2. The system of claim 1, wherein the controller is configured to receive intercom instructions generated by the web-based interface from the district server over the district network, parse the intercom instructions to determine intercom events, store the intercom events and transmit control signals to the intercom equipment based on the intercom events.

3. The system of claim 1, wherein the controller is configured to operate in a local mode absent communication with the district server such that the controller independently controls the intercom equipment associated with the district location.

4. The system of claim 3, wherein the controller operates in the local mode during at least one of an emergency notification procedure, a lockdown check-in procedure, a paging event and a relay control event.

5. The system of claim 2, wherein the at least one intercom system further comprises an administrative console communicatively coupled to the network switch and configured for providing single point administrative functionality at the at least one intercom system.

6. The system of claim 5, wherein the intercom equipment associated with the district location comprises at least one Internet Protocol (IP) room module and the IP room module interfaces with a speaker/microphone to provide bi-directional audio functionality between a zone out of the plurality of zones and the administrative console.

7. The system of claim 6, wherein the at least one IP room module further interfaces with a call switch, wherein upon actuation of the call switch the IP room module configures the microphone to communicate with the administrative console.

8. The system of claim 6, wherein the at least one IP room module further interfaces with a check-in switch, wherein upon initiation of an emergency event within the district location, actuation of the check-in switch indicates, at a centralized emergency console, that the zone associated with the at least one IP room module is not in immediate danger.

9. The system of claim 8, wherein a subsequent actuation of the check-in switch or placement of a post check-in emergency call-in indicates, at the centralized emergency console, that the zone associated with the at least one IP room module is in immediate danger.

10. The system of claim 6, wherein the at least one intercom system further comprises a paging module configured to receive an IP based audio signal, decode the IP based audio signal into an analog audio signal and output the analog audio signal to external audio amplifiers.

11. The system of claim 10, wherein the paging module is operably coupled to an alert light and configured to activate the alert light upon receiving a control signal from the controller indicating activation of the alert light.

12. The system of claim of claim 10, wherein the at least one intercom system further comprises an Input/Output (I/O) module operably coupled to an external device and configured to activate and deactivate functionality of the external device.

13. The system of claim 12, wherein the external device is a door latch associated with a door within a zone of the district location and the I/O module is configured to lock or unlock the door latch based on the control signals from the controller.

14. A method of operating an intercom system within a district location during an emergency, the method comprising:
receiving an initiation signal at a controller for an intercom system of the district location, the initiation signal indicating that an emergency event is presently occurring within the district location;
accepting check-in messages from one or more system devices located within the intercom system of the district location, the check-in messages indicate that the one or more system devices are not in immediate danger from the emergency event;
generating a check-in exception list upon the expiration of a check-in timer, the check-in list provides an indication that a specific system device has provided a check-in message; and
displaying the check-in exception list at a designated console.

15. The method of claim 14, further comprising terminating non-emergency functionality of the intercom system subsequent to receiving the initiation signal at the controller.

16. The method of claim 15, further comprising:
initiating an all clear message signaling an end to the emergency event;
emptying the check-in exception list;
terminating the display of the check-in exception list at the designated console; and
restoring non-emergency functionality of the intercom system.

17. The method of claim 14, further comprising updating the check-in exception list to include system devices that have provided more than one check-in message or a call in message.

18. The method of claim 17, further comprising establishing a stealth mode call in from the system devices that have provided more than one check-in message or the call in message.

19. The system of claim 18, wherein the controller can selectively turn on or off the stealth mode of communication by zones, including groups of rooms or single rooms within the district location, or individual system devices.

20. The method of claim 18, further comprising prohibiting the system devices that have provided more than one check-in message or the call in message from updating to a checked in state until the call in is answered or terminated.

21. The method of claim 14, further comprising establishing stealth mode audio communication with the one or more system devices located within the intercom system during the emergency event.

22. A district datacenter providing control for a plurality of intercom systems located within a plurality of locations within a district administered by the district datacenter, the district datacenter comprising:
one or more servers configured to administer the plurality of intercom systems; and
a user interface being hosted by the one or more servers and accessible by a computing device;
wherein the user interface is configured to accept user credentials and provide access to a setup and control interface for each intercom system of the plurality of intercom systems to which the user credentials indicate a user has access.

23. The district datacenter of claim 22, wherein the user interface includes an intercom system setup interface that allows setup of individual components of a specific intercom system of the plurality of intercom systems prior to the individual components being integrated into the specific intercom system.

24. The district datacenter of claim 23, wherein the intercom system setup interface accepts a Media Access Control (MAC) address, an Internet Protocol (IP) address and a logical binding of the individual components of the specific intercom system prior to the individual components being integrated into the specific intercom system.

25. The district datacenter of claim 24, wherein upon integration of the individual components into the specific intercom system, the specific intercom system will automatically detect the individual components at the MAC address, IP address and devices type of the individual components prior to and in place of these properties being entered by a user into the specific intercom system.

26. The district datacenter of claim 22, wherein the user interface includes a dial string extension setup interface that accepts a number that upon being dialed by an external Session Initiation Protocol (SIP) phone, performs a specified intercom system function.

27. The district datacenter of claim 22, further comprising a streaming audio input module configured to rebroadcast an audio signal from an outside device over a multicast stream to specified locations within the plurality of intercom systems.
